(19) United States
(12) Patent Application Publication
(10) Pub. No.: US 2004/0064385 A1
(43) Pub. Date: Apr. 1, 2004

(54) Method of centralized parts segregation

(76) Inventor: Desmond Tamaki, Torrance, CA (US)

Correspondence Address: ARMSTRONG, KRATZ, QUINTOS, HANSON & BROOKS, LLP, 1725 K STREET, NW, SUITE 1000, WASHINGTON, DC, 20006, US

(21) Appl. No.: 10/259,825

(22) Filed: Sep. 30, 2002

(51) Int. Cl. G06F 17/60

(52) U.S. Cl. 705/29

(57) ABSTRACT

A parts warehousing system has a plurality of parts warehouses, one or more hubs and one or more suppliers. A method for stocking parts in the parts warehouses of the system, includes, ordering parts from a supplier, receiving advance notice of the shipment from the supplier, and generating a deployment ticket for each part, wherein the deployment ticket includes information regarding the specific location in the warehouse in which the part is to be stocked. Received parts are tagged with the appropriate deployment ticket, segregated at the hub and shipped to the appropriate warehouse.

### BACKGROUND OF THE INVENTION

Field of the Invention

This is a method for improving shipments of parts from a supplier to a plurality of parts warehouses (or parts centers). More particularly, this method is directed to receiving parts from a supplier at one or more hubs and then shipping them to a plurality of parts warehouses.

In an industry where it is necessary to provide many parts to many different locations nationwide and worldwide, it is necessary to many parts warehouses at many different locations. While this discussion will describe a nationwide system, it is to be understood that it would also apply to a worldwide system. Many industries which supply consumer products require regional or local warehouses throughout the country. Other industries not specifically directed to consumer products also have such a need. Industries, such as the transportation industry, consumer appliances, consumer electronics, and many more need, for example, regional parts warehouses. As an example, auto manufacturers typically need to have regional parts warehouses to supply the demand for auto parts for the vehicles they build. Because of the need for auto repairs, the regional parts warehouses are beneficial because they provide a supply of parts reasonable near the consumer. Generally, in the auto industry, the parts warehouses sell their parts to the auto dealers, who install the parts or resell them to private repair shops, etc. Of course, many industries have these same systems.

In many industries, when parts are ordered from the suppliers, parts are shipped directly from the supplier to one of a plurality of regional parts warehouses. Many of the parts warehouses order their own parts. When these parts arrive, the warehouses usually needed to segregate the parts into groups corresponding to locations in the warehouse to be stocked. These parts are then stocked in the proper locations in that warehouse. This segregating process takes up a great deal of space, which is not readily available at a warehouse. The segregating step also takes a great deal of time.

With today's economic climate, there is increasing pressure to reduce costs in all areas of a company's operations. This takes the form of a requirement for all areas of operation to be more efficient. In this instance, parts operations may be more efficient by reducing inventory on hand and by streamlining the parts procurement and delivery operations. By more efficiently moving parts to warehouses, inventories may be reduced, and thus costs may be reduced.

### SUMMARY OF THE INVENTION

The method for improving efficiency of delivering parts to plural parts warehouses includes employing one or more hubs for receiving the parts from the suppliers and then distributing them to the individual parts warehouses. Because the parts warehouses have little space for segregating incoming parts, it is beneficial for the segregating or sorting process to take place at the hub. This segregation of the parts arriving at the hub from the supplier is an activity that the hub is designed to do and the people that perform these segregating functions are specialists at performing that job.

A hub used in this method will generally include a main stocking area, a cross-dock, and an office area. The main stocking area generally consists of shelves where many different parts are stocked for delivery to the parts warehouses, as necessary. The cross-dock is a type of loading area having a receiving side and a shipping side, generally opposite the receiving side. The theory of a cross-dock is that parts are received and then shipped out without ever being stocked into the main stocking area of the hub. More specifically, a cross-dock is a facility in which parts from multiple suppliers are received on the receiving side and are stored for a short time, usually less than a day, before they are segregated and shipped out the other side of the cross-dock to multiple parts warehouses. In the segregation process, for example, parts from a single supplier are segregated and packed into crates destined for individual parts warehouses.

In this context, a mixing center is a variation of the cross-dock system. In a hub with a mixing center, parts are received from the supplier and are segregated according to each parts warehouse to which they are destined. Also parts are segregated again and packed into crates which are labeled for a specific location at the destination parts warehouse. Also, parts received from the supplier may be stocked directly to the main stocking area of the hub and parts which have been stocked in the main stocking area of the hub may be shipped to a parts warehouse, as needed. Thus, there is a great deal more activity in the mixing center than just receiving on one side and shipping out on the other.

A deployment ticket is generated at the hub before the part arrives at the hub. The deployment ticket includes information describing the individual part or group of parts (such as multiple parts packaged together. The deployment ticket also includes the location where the part is to be stocked. This location includes the row/aisle where the part is to be stocked, and may also include the specific location within that row/aisle.

When the parts from the supplier are off loaded on the receiving side of the mixing center, the appropriate deployment ticket is attached to the received parts. The parts are then segregated into areas representing different parts warehouses, and then segregated into different specific locations within that warehouse. The segregated parts are then packed into a crate having a label with the specific location within a specific parts warehouse to which the parts are to be delivered. The individual crates are then loaded onto a truck or other form of transportation bound for the specific warehouse indicated on the crate label. Once the crate arrives at the designated parts warehouse, the crates are off loaded and each crate, designated for a certain row/aisle indicated on the deployment ticket, is then taken to the specified row/aisle and unloaded, without the need for segregating the parts into individual row/aisle designations at the part warehouse.

### BRIEF DESCRIPTION OF THE DRAWINGS

FIG. 1 is a general description of the flow of auto parts from the supplier to the customer, in accordance with this method. The parts are first shipped from the suppliers to the hub, then to the parts warehouses, then to the dealers and ultimately to the end customer.

FIG. 2 is a flow chart representing the flow of the parts from the supplier to the parts warehouse.

FIG. 3 illustrates the supply chain with two hubs, multiple suppliers and multiple parts parts warehouses.

FIG. 4 illustrates a cross-docking set up with a Mixing Center.

FIG. 5 is an illustration of the prior art where the parts are segregated at the parts warehouses;

FIG. 6 is an example of a deployment ticket;

FIG. 7 is an illustration of the movements of parts from the supplier to the parts warehouse; and

FIG. 8 is a schematic diagram illustrating different method of segregation by the customized packing teams.

### DETAILED DESCRIPTION OF THE INVENTION

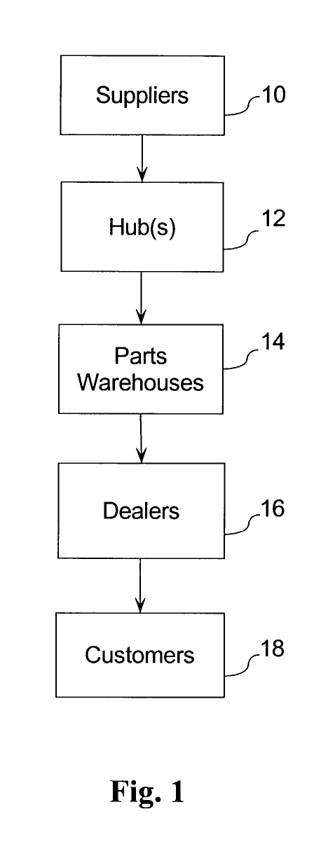

FIG. 1 shows the general flow of parts from a supplier to the ultimate customer in accordance with the instant method. While this description will be conducted with regard to the supply of auto parts, it is clearly applicable to almost any type of parts operation. A supplier 10 of auto parts ships parts to a hub 12. There may be more than one hub 12. In some cases two hubs 12 are used in order to be closer to parts warehouses or to stock different parts. For simplification purposes, this discussion will only refer to one hub 12, but additional hubs may be used. Hub 12 segregates parts, as will be discussed below, and ships them to the individual parts warehouses 14. The parts warehouses 14 stock the parts and then sell them to the dealers 16, as needed. Dealers 16 then use the parts for repair, sell them to independent repair shops or individual customers.

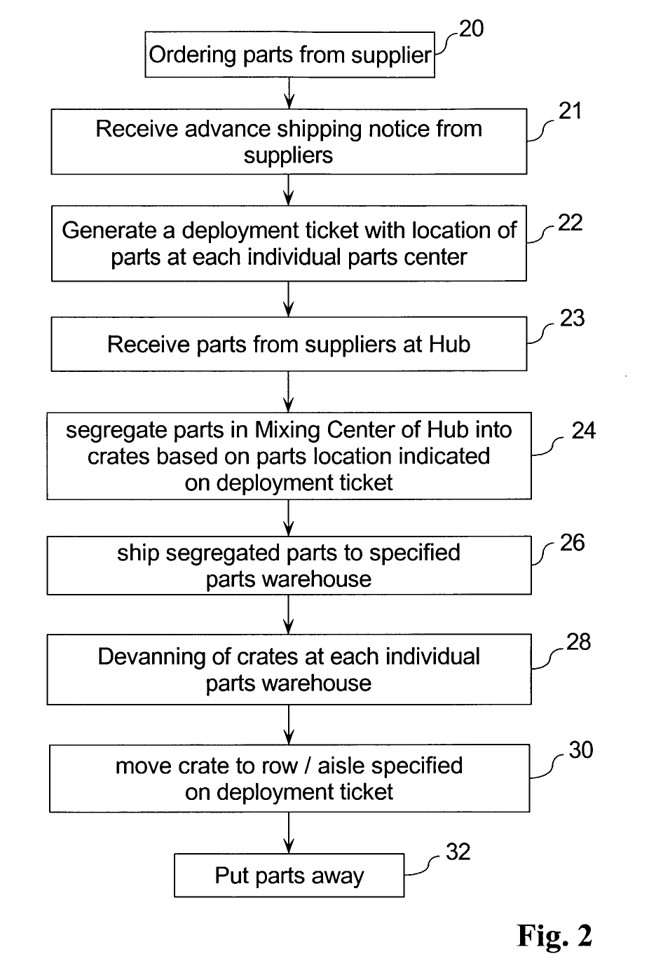

FIG. 2 illustrates a more detailed flow chart illustrating the flow of parts from the supplier to the parts warehouse. Step 20 illustrates ordering a part from the supplier. Step 21 illustrates receiving an advance shipping notice from the supplier indicating that the parts have been shipped. A deployment ticket is generated at step 22. The deployment ticket has the location where the parts are to be shipped (the specific parts warehouse) as well as the specific location where the part is to be stocked in that warehouse. Step 23 indicates that the parts are received at the hub. In step 24, the parts received at the hub are segregated in the mixing center into discreet groups of parts destined for each of the different parts warehouses. The parts are packed into crates depending on the location at the parts warehouse where the specific part is to be stocked. For example, each crate is labeled for a specific row or aisle at the parts warehouse. The parts to be stocked into that specific row or aisle are put into the crate with the corresponding row/aisle number. Step 26 then indicates that the parts are shipped to the specified parts warehouse. Step 28 calls for the devanning of the crates at each individual parts warehouse. Devanning of the crates refers to removing them from a truck or other form of transportation in which they arrived. At step 30, the crates are moved to the row/aisle specified on the crate label, and on the deployment tickets on the individual parts in the crate. In step 32, the individual parts are put away in their designated places.

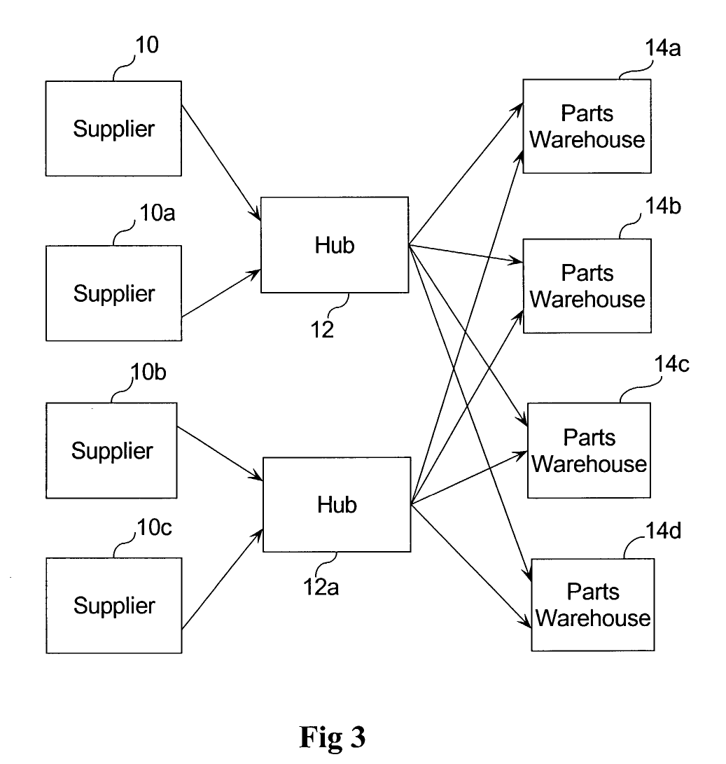

FIG. 3 is a block diagram illustrating the supply chain with two hubs 12, 12a, multiple suppliers 10, 10a, 10b, 10c, and multiple parts warehouses 14a, 14b, 14c, 14d. As noted above, only one hub is necessary, but the instant method may also be carried out with two or more hubs. FIG. 3 illustrates suppliers 10 and 10a supplying hub 12 and suppliers 10b and 10c supplying hub 12a. Alternatively, all of the suppliers may supply both hubs. Both of hubs 12 and 12a supply all of the parts warehouses 14a-14d.

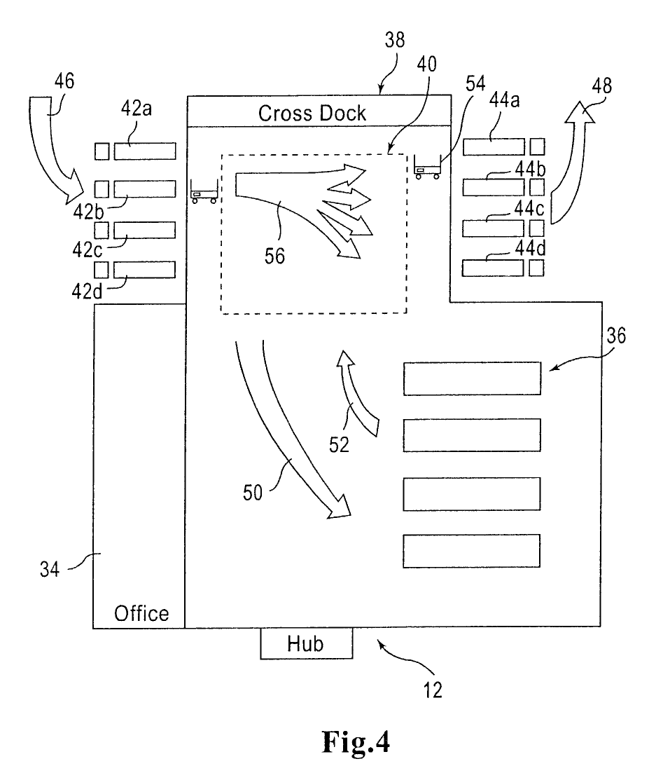

FIG. 4 generally illustrates a cross-dock set up with a mixing center. More specifically, a hub is generally indicated by arrow 12. This hub includes an office area 34, a main stocking area 36, and a cross-dock, generally indicated by reference numeral 38. Mixing center 40 is the area where the segregation and other related activities occur. On the left side of the cross-dock, arrow 46 illustrates the receiving side. Trucks 42a-42d are unloading parts from suppliers. Of course, parts may arrive in many ways, by truck, by train, etc. For the purposes of this discussion, trucks 42a-42d are considered to be from different suppliers, although they certainly could all be from the same supplier. Arrows 56 generally indicate the flow of parts from the receiving side to different trucks at the shipping side. Further, for the purposes of this discussion, trucks 44a-44d are trucks destined for different parts warehouses. Of course, other modes of transportation than trucks may be used to deliver parts to the individual parts warehouses. Reference numeral 54 refers to a crate in which the parts are shipped to the individual parts warehouses. Crates 54 are reusable and are sized to evenly fit inside of a standard trailer. In the United States, standard trailer are generally 48 feet long or 53 feet long. Furthermore, the crates 54 are designed so that they may evenly fit within one of the standard trailers, without having unused room due to the shape or size of the crates. Crates 54 may also be sized to fit within a standard shipping container, which is 40 feet long. Once crates 54 are packed in the mixing center 40, they are not unpacked until they are moved to the specific row/aisle of the destination parts warehouse. Arrow 50 represents the flow of parts received from suppliers that are to be put away in the main stocking area 36 of the hub. Further, arrow 52 represents the flow of parts from the main stocking area 36 of the hub to the mixing center 40 to be sent on to individual parts warehouses.

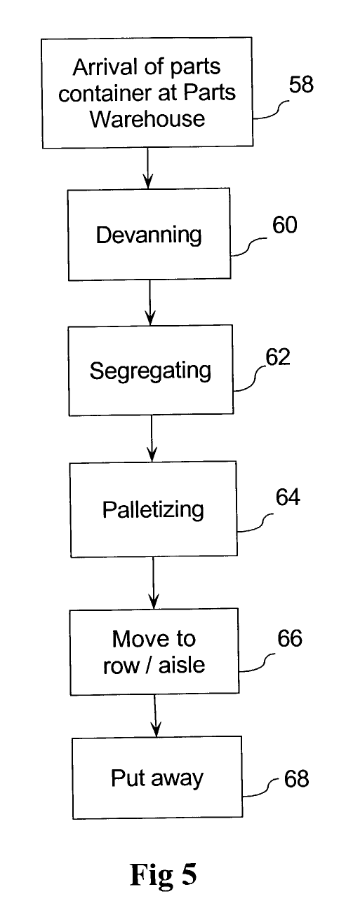

FIG. 5 illustrates a conventional way of delivering parts to a parts warehouse. Step 58 indicates the arrival of parts at a parts warehouse, shipped directly from the supplier. Step 60 illustrates the devanning step in which the crates containing parts from the supplier are off loaded from the truck or other mode of transportation. At step 62, the parts are segregated at the parts warehouse into groups corresponding to the different rows/aisles in the parts warehouse. The groups are then palletized at step 64 and they are moved to the designated row/aisle in step 66. In step 68, the parts are then put away in their designated place or bin. As noted earlier, the step 62 of segregating the parts into groups corresponding to their stocking location is a job that is inefficient to do at the parts warehouse itself. There is usually not sufficient room in the parts warehouse to do the segregating, and it also causes a delay in stocking the parts in their proper places.

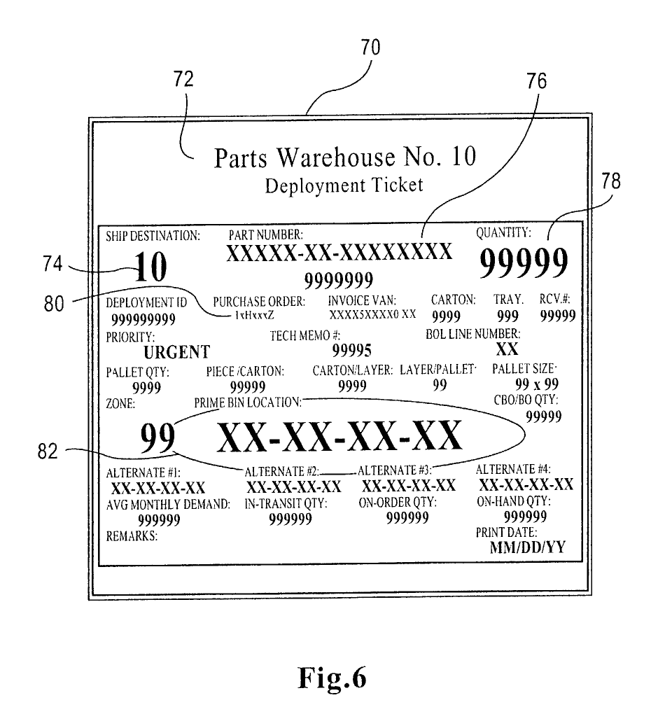

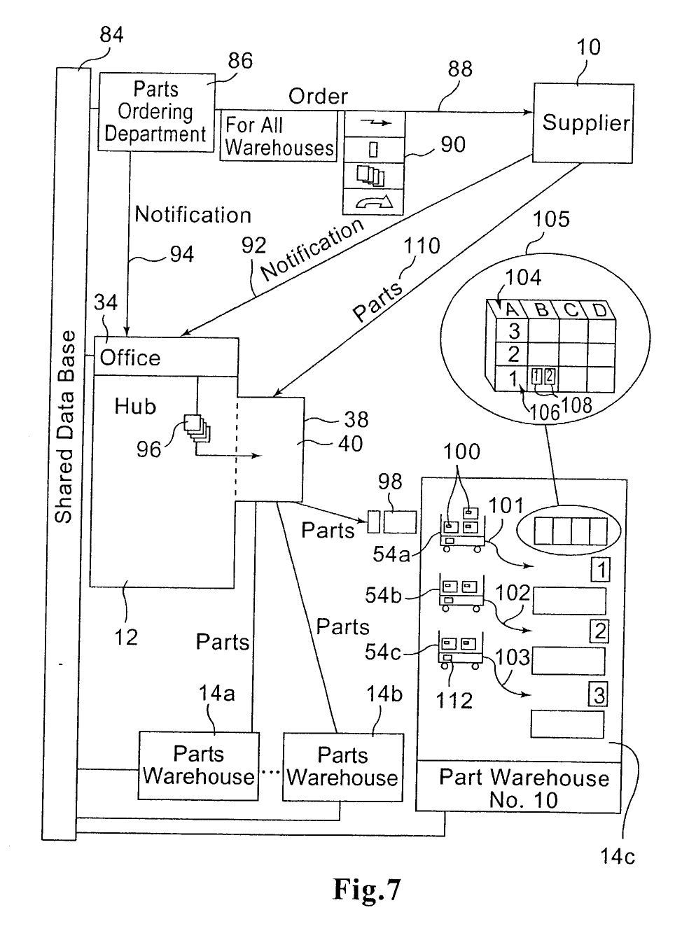

FIG. 6 illustrates a deployment ticket generated at the hub before the ordered parts arrive at the hub. Reference numeral 70 generally refers to a deployment ticket. Reference numeral 72 refers to the specific parts warehouse (Parts Warehouse No. 10) to which the parts are to be shipped. The number of the specific parts warehouse is indicated at 74. Reference numeral 76 indicates the specific part number to which the deployment ticket applies, and reference numeral 78 refers to the quantity of that part number shipped. Reference numeral 80 refers to the purchase order number of which this deployment ticket is a part. Further, reference numeral 82 refers to the prime bin location at the parts warehouse where the specified part is to be stocked. As illustrated, this location has 8 alphanumeric characters to signify the location at the parts warehouse. Of course, more or fewer characters could be used. For example, four groups of two characters could represent: aisle; sector; shelf; and bin (See FIG. 7). Many other combinations are also possible in coding the location in the parts warehouse in which the part is to be stocked.

FIG. 7 is a schematic illustration of the method of the instant invention. A parts order originates at the parts ordering department 86. The order 88 is conveyed to supplier 10 by any conventional order method, such as electronically, by fax, by hard copy, by telephone, or by any other acceptable method. The parts ordering department may also send a notification 94 to the hub that the order has been made. Also, the parts ordering department may be linked into a common data base 84 with the hub and the parts warehouses to improve communications. Supplier 10 sends an advance shipping notice 92 to the hub and/or the parts ordering department 86.

The parts are shipped at 110 to the hub 12. After receiving the advance shipping notice 92, the hub 12 generates the deployment tickets 96 for the parts 110 expected to arrive. Deployment tickets 96 are then transferred to the mixing center 40 of the cross-dock 38. Deployment tickets are associated with the proper received parts at the mixing center 40. The parts are then packed into the crates corresponding to the parts warehouse destination located on the deployment ticket. The crates are then loaded onto the truck (or other transportation mode) corresponding to the parts warehouse destination on the deployment tickets 96. The truck 98 then transports the crates to the properparts warehouse.

Truck 98 is illustrated as unloading its cargo at Part Warehouse No. 10 (reference numeral 14c). As an example, crates 54a, 54b, and 54c have been unloaded at warehouse 14c. Crates 54a, 54b, and 54c are illustrated as having parts therein, and each part having a deployment ticket 100 thereon. Furthermore, each crate 54a, 54b, and 54c have a crate label indicating which row/aisle that crate it to be delivered to. Arrow 101 indicated that crate 54a is delivered to aisle 1. This, of course, is the same aisle location printed on the deployment tickets for those parts in that specific crate. Likewise, crate 54b is delivered to aisle 2 and crate 54c is delivered to aisle 3.

As described above, the deployment ticket may even contain more specific information that just the row/aisle in which the associated part is to be stocked. For example, reference numeral 105 is an enlargement of the stocking shelves in a parts warehouse. Each stocking shelf may be broken down into sectors 104 (A,B,C,D), shelves 106 (1,2,3) and even bins 108 (1,2) within a shelf. Even such detailed location information maybe included in the deployment ticket. Of course, there are many other appropriate ways to designate part locations in a parts warehouse.

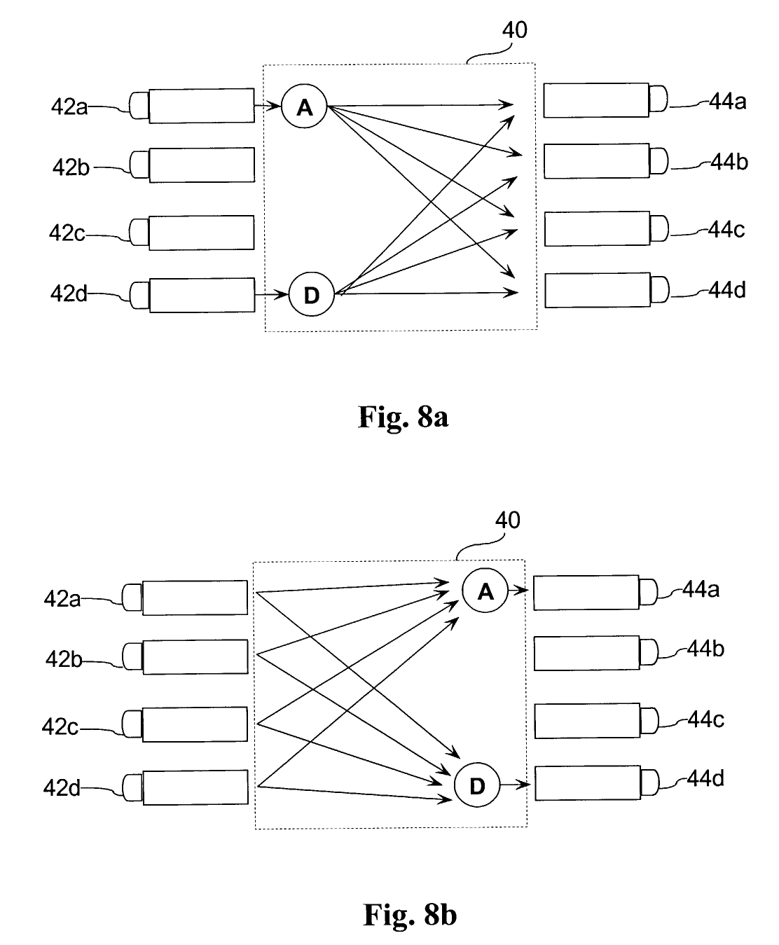

FIGS. 8a and 8b illustrate different methods that may be used by the customized packing teams in the mixing center to segregate the received parts into proper order for shipping to the parts warehouses.

FIG. 8a illustrates a method where trucks 42a-42d represent trucks from four different suppliers. Trucks 44a-44d represent four trucks destined for different parts warehouses. In a simplified form, in mixing center 40, packing team A is dedicated to a single supplier truck 42a. The packing team A segregates all the parts from that one supplier and then packs them into the appropriate crate for any of the trucks 44a-44d departing for different parts warehouses. Accordingly, team D is dedicated to a single supplier truck 42d.

On the other hand, FIG. 8b illustrates a method in which packing team A is dedicated to a single parts warehouse truck 44a. Therefore, team A segregates parts from any of supplier trucks 42a-42d, and packs them only into crates destined for a single parts warehouse to be served by truck 44a. Accordingly, packing team D segregates parts from any of supplier trucks 42a-42d, and packs them only into crates destined for a single parts warehouse to be served by truck 44d. Of course, many other schemes for organizing the packing teams may be used.

I claim:

1. In a parts warehousing system having a plurality of parts warehouses, one or more hubs, and one or more suppliers, a method for stocking parts in the parts warehouses, comprising the steps of:
ordering parts from a supplier;
receiving an advance shipping notice from the supplier indicating that specific parts which have been ordered have been shipped;
generating a deployment ticket at the hub for each one of said ordered parts, said deployment ticket including information corresponding to a specific parts warehouse to which the ordered part is to be shipped and a specific location within the specified warehouse where the part is to be stocked;
receiving, from the supplier, the ordered parts at the hub;
applying said deployment tickets to individual parts or groups of parts;
segregating parts arriving from the supplier into discreet groups destined for each individual parts warehouse;
further segregating parts destined for each individual parts warehouse into discreet sub groups representing a specific location at said individual parts warehouse;
packing said sub groups of parts into crates having labels indicating a location at the parts warehouse, wherein that locations indicated on the create label and the deployment tickets on the parts packed therein correspond with one another;
shipping said parts to the individual warehouse indicated on the crate label and on the deployment tickets;
receiving said shipped parts at the designated parts warehouse;
moving each crate received at the parts warehouse directly to the location indicated on the crate label; and
stocking said parts into the specific location indicated on the deployment ticket.

2. The method of claim 1, wherein said hub maintains a database, said database having information corresponding to the part location for each part (part number) at each of said parts warehouses.

3. The method of claim 1, wherein customized packing teams are used to perform the segregating steps, each customized packing team dedicated to segregating parts destined for a specific parts warehouse.

4. The method of claim 1, wherein customized packing teams are used to perform the segregating steps, each customized packing team dedicated to segregating parts originating from a specific supplier.

5. The method of claim 1, wherein said deployment ticket is automatically generated in response to receipt of the advance shipping notice.

6. The method of claim 5, wherein said deployment ticket is generated electronically at said hub, and printed out on the day the associated parts are scheduled to arrive.

7. The method of claim 1, wherein said ordering step includes providing a unique purchase order number for each purchase order, wherein one purchase order includes parts for all of said parts warehouses.

8. The method of claim 7, wherein said purchase order number supplied to said supplier is printed on said deployment ticket for each received part.

9. The method of claim 1, wherein said hub and said parts warehouses share the same database with a centralized parts ordering department.

10. The method of claim 9, wherein said ordering step includes ordering parts for all parts warehouses by said centralized parts ordering department.

11. The method of claim 1, further comprising the step of adding stock from the hub to the crates, for supplementing the parts to be sent to one of the parts warehouses.

12. The method of claim 1, wherein said crates are reusable.

13. The method of claim 1, wherein said crates are sized such that they evenly fit within a standard trailer.

14. The method of claim 1, wherein said crates are sized such that they evenly fit within a standard cargo container.

15. In a parts warehousing system having a plurality of parts warehouses, one or more hubs, and one or more suppliers, wherein said hub and said parts warehouses share a database, a method for stocking parts in the parts warehouses, comprising the steps of:
electronically ordering parts from a supplier;
receiving an advance shipping notice from the supplier indicating that specific parts which have been ordered have been shipped;
automatically generating a deployment ticket at the hub for each one of said ordered parts, said deployment ticket including information corresponding to a specific parts warehouse to which the ordered part is to be shipped and a specific location within the specified warehouse where the part is to be stocked, said generating step including printing out the deployment ticket on the day the part is scheduled to arrive at the hub;
receiving, from the supplier, the ordered parts at the hub;
applying said deployment tickets to individual parts or groups of parts;
segregating parts arriving from the supplier into discreet groups destined for each individual parts warehouse;
further segregating parts destined for each individual parts warehouse into discreet sub groups representing a specific location at said individual parts warehouse; wherein said segregating steps are accomplished by using customized packing teams;
packing said sub groups of parts into reusable crates having labels indicating a location at the parts warehouse, wherein that locations indicated on the crate label and the deployment tickets on the parts packed therein correspond with one another, said reusable crate being sized to evenly fit within a standard trailer;
shipping said parts to the individual warehouse indicated on the crate label and on the deployment tickets;
receiving said shipped parts at the designated parts warehouse;
moving each crate received at the parts warehouse directly to the location indicated on the crate label; and
stocking said parts into the specific location indicated on the deployment ticket.

16. The method of claim 15, wherein the database shared by said hub and said parts warehouses maintains information corresponding to the part location for each part at each of said parts warehouses.

17. The method of claim 15, wherein said ordering step is accomplished by a centralized parts ordering department, which shares the same database as the hub and parts warehouses.

18. The method of claim 15, wherein said ordering step includes ordering parts for all parts warehouses by said centralized parts ordering department.

19. The method of claim 15, wherein said ordering step includes providing a unique purchase order number for each purchase order, wherein one purchase order includes parts for all of said parts warehouses.

20. The method of claim 15, further comprising the step of adding stock from the hub to the crates, for supplementing the parts to be sent to one of the parts warehouses.
